(19) United States
(12) Patent Application Publication
(10) Pub. No.: US 2009/0103684 A1
(43) Pub. Date: Apr. 23, 2009

(54) MOLYBDENUM-MOLYBDENUM BRAZING AND ROTARY-ANODE X-RAY TUBE COMPRISING SUCH A BRAZING

(75) Inventor: Axel Konrad Vetter, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,734

(22) PCT Filed: Oct. 21, 2005
(86) PCT No.: PCT/IB05/53453

§ 371 Date: Apr. 23, 2007

(30) Foreign Application Priority Data
Oct. 26, 2004 (EP) 04105294.5

(51) Int. Cl. H01J 9/00; H01J 35/10

(52) U.S. Cl. 378/144; 445/28

(57) ABSTRACT

The present invention relates to a method for providing a molybdenum-molybdenum or molybdenum alloy-molybdenum alloy brazing. In accordance with the invention this method comprises the following steps: —providing at least two parts (16, 22) made of molybdenum or a molybdenum alloy; —brazing together said two parts (16, 22) using a brazing material (26); and—providing a plasma-sprayed molybdenum of molybdenum alloy layer (28) at least on a portion of the brazing material (26) that would be accessible otherwise. Furthermore, the present invention is directed to a rotary-anode X-ray tube (14) which is equipped with a spiral groove bearing (12) comprising, as a first part (16), an axle blank (16) having a center bore (18) and being made of molybdenum or a molybdenum alloy and, as a second part (22), a cap (22) made of molybdenum or an molybdenum alloy, wherein, for closing one open axial end (24) of said axle blank (16), said axle blank (16) and said cap (22) are brazed together using the method in accordance with the invention.

The present invention relates to a method for providing a molybdenum-molybdenum or molybdenum alloy-molybdenum alloy brazing, comprising the following steps:

providing at least two parts made of molybdenum or a molybdenum alloy; and

brazing together said two parts using a brazing material.

Furthermore, the present invention relates to a rotary-anode X-ray tube which is equipped with a spiral groove bearing comprising, as a first part, an axle blank having a center bore and being made of molybdenum or a molybdenum alloy and, as a second part, a cap made of molybdenum or a molybdenum alloy.

Without being limited thereto, the above-mentioned brazings may for example be necessary in connection with spiral groove bearings, particularly spiral groove bearings for high power x-ray tubes. The principle of spiral groove bearings is very similar to the aquaplaning effect on wet surfaces. A hydrodynamic wedge which molds between the rotating and the stationary parts of the bearing causes a “floating” of the rotating part, thus forming a gap filled with liquid metal between the parts. Due to the requirements of electrical conductivity and extremely low vapor pressure, only gallium-based alloys are suitable as metals in the liquid state forming the lubricant. Unfortunately, gallium alloys have the property of corroding or dissolving nearly all commonly used metals. Molybdenum is the only material (besides W, Ta and some ceramics) which withstands the extremely aggressive lubricant, particularly GaInSn, in a vacuum up to 300° Celsius, for a long time. All other metals and alloys are dissolved in GaInSn. This would pollute the gallium alloy and could produce hard particles in the lubricant.

The term “spiral groove bearing” as used herein is intended to cover all kinds of bearings which work according to the above-mentioned principle. For example, the grooves need not be truly spiral in practical embodiments, but may comprise any configuration that leads to the above-mentioned “floating” effect, for example a helix.

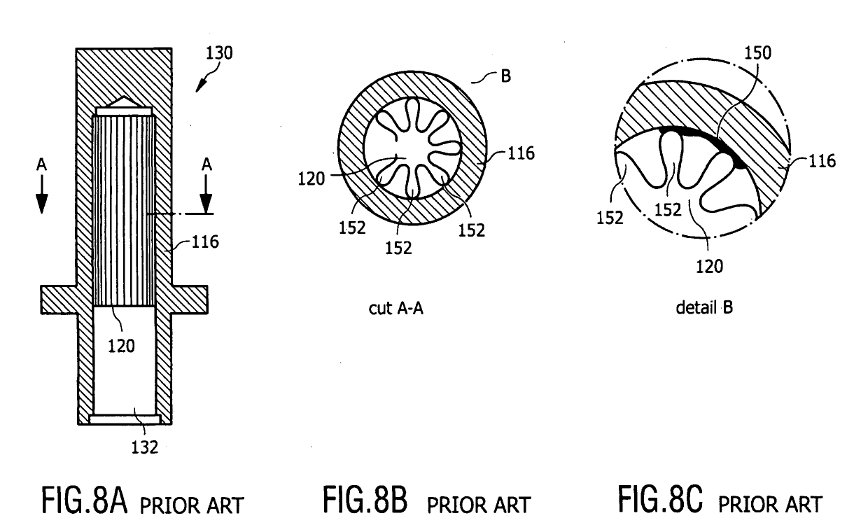

In high power X-ray tubes, spiral groove bearings are for example used for bearing the anode which rotates at a very high speed. For example, with such rotary-anode X-ray tubes it is necessary to cool the tube. To achieve, or at least support, this cooling, there already are known spiral groove bearings having an axle comprising a cavity in which a copper heat sink is provided. Such an axle is shown in FIGS. 8A, 8B and 8C. Referring to FIG. 8A, there is provided an axle 130 consisting of a molybdenum axle blank 116 comprising a cavity 132. Within the cavity 132 there is provided a copper heat sink 120. As can be seen in FIGS. 8B and 8C, the latter showing detail B of FIG. 8B, the copper heat sink 120 comprises a plurality of copper lamellas 152. As can be seen in FIG. 8C, the copper heat sink 120 is brazed to the axle blank 116 by a brazing material 150. A spiral groove bearing using an axle 130 of the type shown in FIGS. 8A, 8B and 8C offers the possibility of managing the heat in X-ray tubes by direct liquid cooling through the bearing axles. The cavity 132 is formed by a blind hole, i.e. the axle blank 116 in accordance with FIGS. 8A, 8B and 8C comprises a one-piece configuration. In accordance with the prior art, this one-piece configuration of the axle blank 116 was necessary since the known brazings did not withstand the extremely aggressive lubricant GaInSn.

It is an object of the present invention to provide a method of the type mentioned in the opening paragraphs by which a brazing can be made that withstands, for example, extremely aggressive lubricants like GaInSn, and to specify a preferred possible use of that method.

In order to achieve this object, a method for providing a molybdenum-molybdenum or molybdenum alloy-molybdenum alloy brazing in accordance with the invention is characterized in that the method further comprises the step of providing a plasma-sprayed molybdenum or molybdenum alloy layer at least on a portion of the brazing material that would be accessible otherwise.

The plasma-sprayed molybdenum or molybdenum alloy layer which covers at least a portion of the brazing material protects this portion for example against extremely aggressive lubricants like GaInSn that would otherwise destroy the brazing material. Thereby, it is for example possible to provide device components consisting of a plurality of parts which are brazed together, but which nevertheless can withstand extremely aggressive lubricants like GaInSn.

In a preferred embodiment of a method in accordance with the invention, said brazing material comprises gold and nickel. For example, gold/nickel 82/18 does not only have good brazing properties but is also very suitable to be coated with the plasma-sprayed molybdenum or molybdenum alloy layer.

A method for providing a molybdenum-molybdenum or molybdenum alloy-molybdenum alloy brazing in accordance with the invention can be used very advantageously in connection with a rotary-anode X-ray tube of the kind mentioned in the opening paragraphs. An X-ray tube in accordance with the invention is characterized in that, for closing one open axial end of said axle blank, said axle blank and said cap are brazed together using a method in accordance with the invention. Preferably at least the portions of the brazing gap material that get into contact with the aggressive lubricant are covered by the plasma-sprayed molybdenum layer, which preferably is a thin dense molybdenum layer. Of course it also possible to provide at least one further plasma-sprayed molybdenum or molybdenum alloy layer on any other portion of a spiral groove bearing that needs to be protected against the aggressive lubricant. For example, compared to electronic beam welding of molybdenum, the brazing process in accordance with the invention is advantageous, since such a welding process has the disadvantage of involving very high temperatures which in some cases can destroy the structure of the molybdenum axle and induce high stress just there. Another known welding technique is friction welding. However, friction welding destroys the structure and the shape of the material in a broad zone. Besides these disadvantages of welding processes, welding is much more expensive than brazing.

In a rotary-anode X-ray tube in accordance with the invention it is preferred that within said axle blank there is provided a heat sink. This heat sink may for example be of the type as discussed above in connection with FIGS. 8A, 8B and 8C.

In accordance with a highly preferred embodiment said axle blank and said heat sink are provided in a one-piece arrangement. Spiral groove bearings with axles comprising an integrally formed heat sink (for example an eroded rip cooler) can remove about twice the amount of heat from a high power X-ray tube, compared to an axle comprising a copper heat sink as discussed with reference to FIGS. 8A, 8B and 8C. In connection with X-ray tubes, the waiting time between different diagnostic cycles during for example a CT application can thus be shortened drastically. Furthermore, it is possible to use axles having a smaller diameter. For example a reduction from presently used 28 mm axles to 24 mm axles would reduce the hydrodynamic friction power by about 45%, since the friction increases by approximately a power of four with the diameter. This in turn makes it possible to reduce the size of the motor used for rotating the anode. Overall power consumption is reduced in this way. Alternatively, with the thinner axle it is possible to raise the rotational speed of the anode, and to have a smaller focal spot on the anode disc, resulting in improved picture resolution.

In a further preferred embodiment of an X-ray tube in accordance with the invention, at least part of said heat sink is formed by wire-cut EDM. Wire-cut EDM is a simple and inexpensive fabrication method which requires a center bore and can therefore be used with an axle blank having such a center bore.

Preferably the heat sink comprises a star-shape configuration. For example, a star-shaped cross section of the heat-sink may be formed by the center bore of the axle blank and radially removed material slices, i.e. the material remaining after the wire-cut EDM process defines the outline of the star.

At least in some cases it is regarded as advantageous that said cap is conical at least in section. For example, the cap may have the form of a frustum which tapers from the outer surface of the axle to the cavity thereof. A conical configuration of the cap, for example, makes it easier to align the cap with respect to the axle blank.

In this connection it is further preferred that an edge of said axle blank is adapted to the form of said cap.

Embodiments of a method for providing a molybdenum-molybdenum or molybdenum alloy-molybdenum alloy brazing in accordance with the invention and of an X-ray tube in accordance with the invention will be described in detail in the following with reference to the drawings, in which

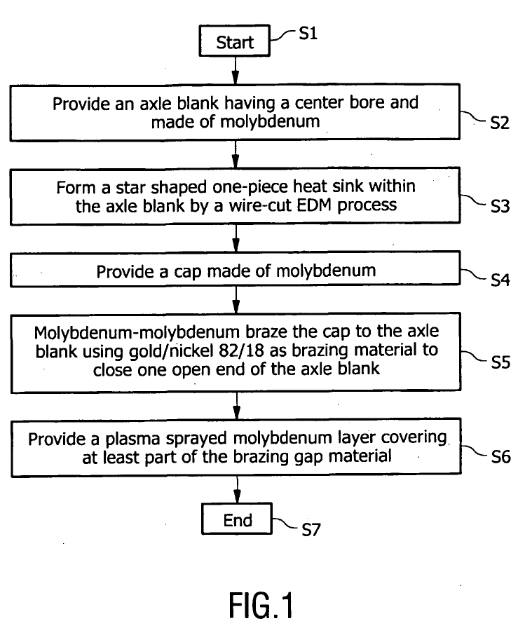

FIG. 1 is a flow chart illustrating an embodiment of the method in accordance with the invention;

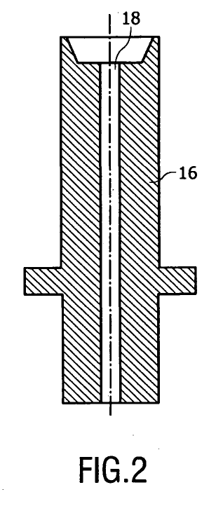

FIG. 2 is a sectional view of an axle blank comprising a center bore;

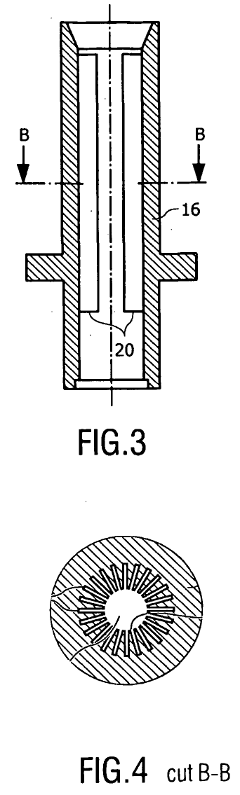

FIG. 3 is a sectional view of the axle blank of FIG. 2 after processing by wire-cut EDM;

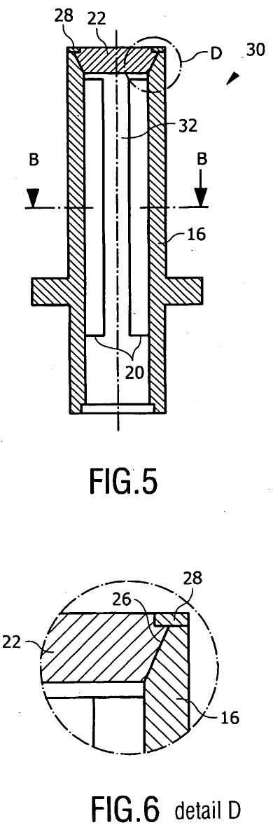

FIG. 4 is a sectional top view taken on the line B-B of FIGS. 3 and 5;

FIG. 5 is a sectional view of the axle blank of FIG. 3 after closing one open end with a cap;

FIG. 6 shows the detail D of FIG. 5;

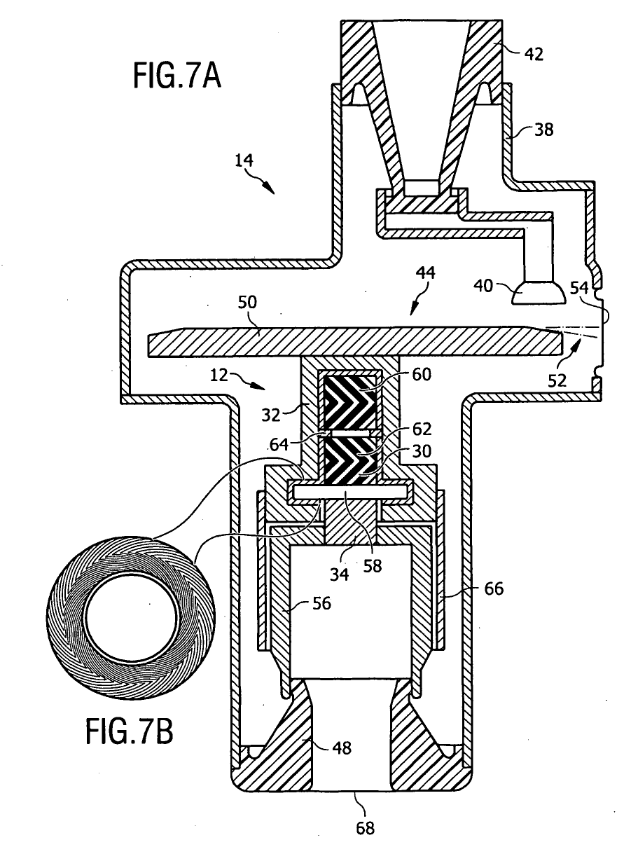

FIG. 7A schematically shows an embodiment of an X-ray tube in accordance with the present invention;

FIG. 7B illustrates a groove pattern used for the spiral groove bearing in the X-ray tube of FIG. 7A;

FIG. 8A is a sectional view of a prior art spiral groove bearing axle in accordance with the prior art comprising a heat sink;

FIG. 8B is a sectional top view taken on the line A-A of FIG. 8A; and

FIG. 8C shows detail B of FIG. 8B.

FIG. 1 is a flow chart illustrating an embodiment of the method in accordance with the invention. The illustrated method starts in step S1. In step S2 an axle blank having a center bore and being made of molybdenum is provided as a first part. In step S3 a star-shaped one-piece heat sink is formed within the axle blank using a wire-cut EDM process. A wire-cut EDM process may be used to form the heat sink, since the axle blank comprises a center bore. Subsequently, in step S4 a cap made of molybdenum is provided as a second part. In step S5 this cap is molybdenum-molybdenum brazed to the axle blank. A suitable brazing material is, for example, gold/nickel 82/18. By brazing the cap to the axle blank one open end of the axle blank is closed. Finally, in step S6 a plasma-sprayed molybdenum layer covering at least part of the brazing gap material is provided. In this context it is preferred that at least the portions of the brazing gap material getting into contact with the aggressive lubricant are covered and thus protected. The method illustrated in FIG. 1 ends in step S7.

FIG. 2 shows an axle blank 16 made of molybdenum and comprising a center bore 18.

FIG. 3 shows a sectional view of the axle blank 16 of FIG. 2 after processing by wire-cut EDM and FIG. 4 shows a sectional top view taken on the line B-B of FIGS. 3 and 5. The heat sink 20 formed integrally with the axle blank 16 comprises a star shaped configuration which is formed by the center bore 18 and removed material portions 36 extending radially. While the heat sink preferably is formed at least partially by a wire-cut EDM process, further processing steps, like drilling or turning, may also be applied, for example for increasing the diameter of the center bore or for forming the upper edge structure shown in FIG. 3.

FIG. 5 shows a sectional view of the axle blank 16 of FIG. 3 after closing one open end with a cap, and FIG. 6 shows detail D of FIG. 5. The frustum-shaped cap 22 is molybdenum-molybdenum brazed to the axle blank 16. A suitable brazing material 26 is for example gold/nickel 82/18. As can be seen best in FIG. 6, there is provided a plasma-sprayed molybdenum layer 28 which is applied in such a manner on the cap 22 and the axle blank 16 that the brazing material 26 is covered. This covering is necessary since the outer surfaces of the axle blank 16 and the cap 22 as well as of the brazing material 26 will get into contact with the aggressive lubricant.

FIG. 7A shows an embodiment of an X-ray tube 14 in accordance with the present invention, and FIG. 7B shows an axial groove pattern used for the spiral groove bearing in the X-ray tube 14 of FIG. 7A. The rotary-anode X-ray tube 14 shown in FIG. 7A comprises a metal housing 38 to which a cathode 40 is secured through a-first insulator 42. Furthermore, a rotary anode 44 is attached to the housing 38 via a second insulator 48. The rotary anode 44 comprises an anode disc 50 on the surface of which facing the cathode 40 X-ray radiation 52 is produced when a suitable voltage is supplied. The X-ray radiation 52 emanates through a radiation emanation window 54. This emanation window 54 is preferably made of beryllium. The anode disc 50 is attached to a housing 32 of a spiral groove bearing 12 in accordance with the invention. The housing 32 is rotatable around an axle 30 formed by two parts (axle blank and cap) brazed together using the method in accordance with the invention. A stem portion 34 of the axle 30 is attached to a carrier 56 which in turn is attached to the second insulator 48. The axle 30 comprises a disc-like broadened portion 58 which defines the axial position of the housing 32 and the anode disc 50. The upper surface of the broadened portion 58 as well as the lower surface thereof comprise a groove pattern as illustrated in FIG. 7B. The portion of the axle 30 extending above the broadened portion 58 is also equipped with two helical groove patterns 60, 62. Between the spiral groove pattern 60, 62 there is provided an annular recess 64. The intermediate space between the four spiral groove patterns and the housing is filled with a liquid lubricant, usually a gallium alloy (GaInSn), as generally known in the art. For rotating the housing 32 and the anode disc 50, a copper rotor 66 is provided at the lower end portion of the housing 30, as is also known in the art.

The heat sink (not shown in FIG. 7A) integrally formed within the axle 30 is accessible via an opening 68 provided in the second insulator 48, such that it is possible to bring the heat sink into contact with a liquid cooling agent to dissipate heat created within the X-ray tube 14 of FIG. 7A.

With a star-shaped heat sink integrally formed within the axle 30 it is, for example, possible to considerably increase the cooling power compared to the brazed copper heat sink used in accordance with the prior art.

Finally, it is to be noted that equivalents and modifications not described above may also be employed without departing from the scope of the invention, which is defined in the accompanying claims.

1. A method for providing a molybdenum-molybdenum or molybdenum alloy-molybdenum alloy brazing, comprising the following steps:
providing at least two parts (16, 22) made of molybdenum or a molybdenum alloy; and
brazing together said two parts (16, 22) using a brazing material (26); characterized in that the method further comprises the step of providing a plasma-sprayed molybdenum or molybdenum alloy layer (28) at least on a portion of the brazing material (26) that would be accessible otherwise.

2. A method according to claim 1, characterized in that said brazing material (26) comprises gold and nickel.

3. A rotary-anode X-ray tube (14) which is equipped with a spiral groove bearing (12) comprising, as a first part (16), an axle blank (16) having a center bore (18) and being made of molybdenum or a molybdenum alloy and, as a second part (22), a cap (22) made of molybdenum or a molybdenum alloy, characterized in that, for closing one open axial end (24) of said axle blank (16), said axle blank (16) and said cap (22) are brazed together using a method according to claim 1.

4. A rotary-anode X-ray tube (14) according to claim 3, characterized in that within said axle blank (16) there is provided a heat sink (20).

5. A rotary-anode X-ray tube (14) according to claim 4, characterized in that said axle blank (16) and said heat sink (20) are provided in a one-piece arrangement.

6. A rotary-anode X-ray tube (14) according to claim 4, characterized in that at least part of said heat sink (20) is formed by wire-cut EDM.

7. A rotary-anode X-ray tube (14) according to claim 4, characterized in that said heat sink (20) comprises a star-shape configuration.

8. A rotary-anode X-ray tube (14) according to claim 3, characterized in that said cap (22) is conical at least in section.

9. A rotary-anode X-ray tube (14) according to claim 8, characterized in that an edge of said axle blank (16) is adapted to the form of said cap (22).
